(19) United States
(12) Patent Application Publication
(10) Pub. No.: US 2025/0342444 A1
(43) Pub. Date: Nov. 6, 2025

(54) Enhanced Auditioning System

(71) Applicants: Nicholas Calhoun, Lewes, DE (US); Erika McFadden, Wilmington, DE (US)

(72) Inventors: Nicholas Calhoun, Lewes, DE (US); Erika McFadden, Wilmington, DE (US)

(21) Appl. No.: 18/387,844

(22) Filed: Nov. 7, 2023

(51) Int. Cl. G06Q 10/1053; G06Q 10/0631

(52) U.S. Cl. CPC G06Q 10/1053; G06Q 10/063112

(57) ABSTRACT

The disclosure teaches a software application intended to enable a method of matching casting roles within the performing arts sector with potential acting talent. The software application disclosed, provides individual facilities to a plurality of casting directors, utilizing their own casting portions exposed to them by the software application to create casting roles. The backend portion publishes the roles to actors engaging the software application via an acting portion that is exposed by the software application individually to each actor. The software application provides the artificial intelligence component which is used as a casting partner, to responsively reply to the actor's audition. Artificial intelligence component can also be used by the software application to assess or make recommendations regarding the audition results. Software application is further configured to contain security features to guard against data tampering.

### FIELD OF THE INVENTION

The present invention relates to identifying talent in the performing art industry, namely, a system and method of connecting talent with available openings.

### BACKGROUND OF THE INVENTION

In the world of entertainment, whether it be theater, film, television, or other performing arts, the process of identifying, auditioning, and selecting actors for specific roles has traditionally been a complex and time-consuming task. Producers and casting directors often grapple with a myriad of challenges in the endeavor to discover the right talent to bring their creative visions to life. These challenges include managing logistics, efficiently coordinating auditions, and ensuring the authenticity of actors' performances during the audition process.

The traditional casting process typically involves a complex process. It begins with role identification where producers and casting directors identify the roles required for a production and create detailed casting descriptions, outlining the characteristics and qualities they are seeking in actors. Then the casting team communicates with talent agents to relay role descriptions and requirements, a process that can be prone to miscommunication or delays. Agents then engage with actors to advise them of available casting opportunities, often involving cumbersome scheduling and coordination. Actors are called to in-person auditions where they perform in front of the casting team. This process can be both costly and time-consuming, especially for actors who may have to travel long distances to audition. In some cases, actors may misrepresent their qualifications or credentials during auditions, leading to suboptimal casting decisions and potential financial and logistical setbacks.

Perhaps the biggest factor that keeps the auditioning process a face-to-face affair is the need to police auditioning processes to prevent forgeries, fakes and tampering. Often the stakes involved in landing a gig are high and the competition for available roles is fierce, which motivates contestants to cheat or use other underhanded means of getting a leg up. Therefore, on the one hand remote auditioning will open more venues and opportunities to both actors and producers, yet the furtive propensity has to this point chilled solutions aiming to make auditioning a more autonomous and remote process.

Additionally, presently art is highly segmented with various solutions solving micro-problems, such as chat integration for example since auditions are generally manual or in-person affairs, assembly and editing of casting roles is done manually or using off the shelf tools, often resulting in one off manuscripts with all other participants working on their own copies of files. There is very little collaborative process between the different participants in the role casting or between actor and publisher of the role. Therefore, it is highly desirable to have a computer enabled tool that will provide common collaboration tools, communication tools, project management tools and talent development and research tools all under one umbrella.

### SUMMARY OF THE INVENTION

The present application discloses a computer-based system designed to match artistic talent with open casting roles that are being filled by casting producers. Disclosed is a computer application comprising of at least three portions, namely, the casting portion, the actor portion and the backend portion. The casting portion is made available to a casting director or producer who serves as the publisher, defining in the casting portion, one or more casting roles along with criteria for the casting role or the talent sought to fill this casting role.

The actor portion is made available to actors, or those seeking opportunities presented by the casting roles published through the casting portion. The actor portion provides actor with the means of submitting their credentials. The actor portion disclosed in this application provides an auditioning platform that an actor may utilize to remotely audition for a casting role. This means that rather than needing to be present with the casting director at the casting site, an actor may be within the comfort and confines of his or her home when auditioning for the casting role. Actors' credentials form actor's data, while actor's audition creates audition data. Together, audition data and actor data are then supplied by the backend portion to the casting portion if the audition data and/or actor data fulfill casting director's requirements for the casting role.

In one embodiment, the auditioning platform provides the tools an actor will need to train for the audition and then record him or herself performing the audition. Then if actor's credentials and audition criteria specified by the publisher of the role for which the actor is auditioning, the actor's audition data will be presented to the publisher for consideration, along with any other actors auditioning for the casting role.

The relationship between the casting portion and the actor portion is managed by the backend portion. The backend portion of the software application receives the casting roles from the publisher, develops the audition process required to collect the audition data. Provides the auditioning computer infrastructure or environment to an actor to make remote auditing possible, and then stores auditing data to either be presented to the publisher, reviewed for future opportunities and roles, or discarded.

It is preferable that the auditioning platform and or the backend portion processes are configured to have an artificial intelligence component. The artificial intelligence component will be configured to provide a responsive conversation with an actor auditioning for a role, as well as record nuances that would not normally be detectable in a live performance or without the artificial intelligence component (“AIC”).

In another embodiment, the AIC may be further configured to provide casting and audition editing recommendation or a matching recommendation linking at least one casting role with at least one actor. The AIC is configured to make its recommendations based on whether the actor's data and/or auditioning data correspond to the criteria of the role that is the subject of the audition. The backend portion then publishes to the casting portion of the publisher, all of the auditioning data and actor data found to correspond to publisher's criteria for the role or roles the publisher is looking to fill.

In another embodiment, the AIC may be configured to produce auditioning data and/or actor data to the dashboard of the casting portion by combining recent auditioning data, or data specifically compiled for the specific casting role, or based on a library of prior auditions for other roles, where auditioning data and/or actor data for an actor is stored in an accessible library within the backend portion, and which can be searchable by the publisher to produced at the publisher's dashboard of the casting portion

The system disclosed in the present application enables a method of filling character roles in the preforming arts comprising the steps of having the backend portion of the software application provide the casting portion to at least one publisher; followed by or concurrently with the step of the backend portion of the software application providing an actor portion to at least one actor. The publisher will utilize the casting portion to publish at least one casting role which would require auditions from a potential pool of actors competing for this casting role.

The casting role is then published by the backend potion to a plurality of actors, who receive within the acting portion of the application available to them. The actor will then utilize auditioning infrastructure of the acting portion to record his or her own audition using equipment available to the actor at home, or wherever the actor is located, which may be a computer a mobile phone or more advanced sound and video equipment. The audition is ais then stored as auditioning data by the backend portion.

The backend portion then links descriptive criteria about the actor, or actor data, with actor's audition for the role or auditioning data. The audition and/or actor data is then compared against the casting role provided by the publisher and/or the criteria for the casting role. The comparison, as well as recommendation steps of the disclosed method may be accomplished by the application with actor data of said actor; said auditioning data and said actor data being provided to said backend portion; said backend portion determining which of a plurality of said auditioning data and said actor data from said plurality of actors corresponds to said casting role; and said backend portion presenting a set of audition data and actor data to said at least one publisher via said casting portion, wherein said set of audition data and actor data corresponds to said at least one casting role.

In one embodiment the disclosed method provides for a step where the publisher may add or modify criteria for any casting role.

The preferred step of the disclosed method is the utilization of an artificial intelligence component (AIC) at the actor portion to assist the actor with his or her audition. One of several ways by which the artificial intelligence component will assist in conducting an auction is by replicating an in person auditioning experience with an interactive experience. For example, the AIC will provide the second or third person, and or narrator of a scene for which an actor as auditioning. As the actor is reciting and acting his or her lines during the audition, the AIC will respond to the actor by impersonating the character with whom the actor is conversing, or by impersonating the narrator between scenes or as a background.

The backend portion with or without the AIC will then integrate security and authenticity data to the audition and actor data to prevent tampering. The step of adding anti-tampering features is preferably always engaged to prevent impersonation, substitution, overwrite and other deep fake methods that may be utilized by someone subscribing to the actor portion.

An additional preferred step has the AIC compare the casting role against a plurality of auditioning and/or actor data to identify a match or a close resembling relationship between the casting role and a criteria for the casting role and the audition and/or acting data. Once the match or close resemblance is identified, the data or a set of audition and actor data is presented to the publisher of the casting role at the casting portion of the computer application.

It should be noted that the backend portion will preferably be a offered as a subscription service to the publisher and actors, who upon creating their profiles, will receive the software environment constituting either the casting portion, which a casting producer will utilize to publish roles and review applicants and their auditions, or the acting portion, which an actor will utilize to review published casting roles based on actor's criteria for the roles and audition for desired roles by utilizing the AIC to first train for the role then record an audition for the role.

It is important to note that just like the casting director, an actor desires to be assured that the recorded audition will not be tampered with or impaired between its recording and its viewing by the publisher. Therefore, the tempering protection disclosed by the system and method provided in the present invention are intended to serve both the publisher and the actor.

### BRIEF DESCRIPTION OF THE DRAWINGS

FIG. 1 is a high-level diagram of the basic processes comprising the disclosed software application.

FIG. 2 describes the basic security features of the computer application.

FIGS. 3 and 4 describe one embodiment of the method disclosed in the application.

FIG. 5A demonstrates a dashboard showing the actor data and audition data.

FIG. 5B demonstrates a dashboard showing the actor data and audition data.

FIG. 6 describes the dashboard exposed by the application process to each publisher, although each publisher receives access to their individual dashboard.

FIG. 7 demonstrates the auditioning platform.

FIG. 8 demonstrates the auditioning screen displayed after an actor had learned his or her lines.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

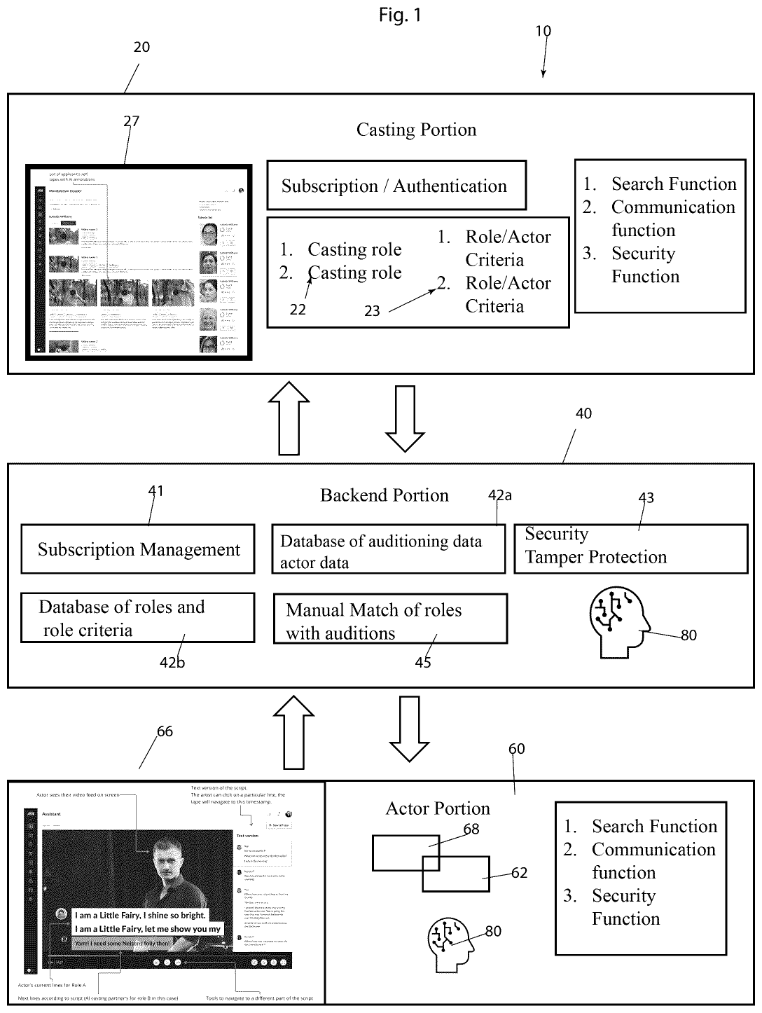

Turning now to FIG. 1 shown is the system 10 configured to match artistic talent with open roles. The system or computer application 10 is shown having at least three portions. The 3 portions are preferably the casting portion 20, the actor portion 60 and the backend portion 40. The three portions of computer application 10 are in data coordination relationship with each other. Meaning that the data created in the casting portion 20 will be the data viewed at the actor portion 40 and at the back portion 60. Alternatively, the data created in any portion may be replicated at the destination portion.

Casting portion 20 is configured to allow the creation of at least one casting role 22. Shown in FIG. 1 the publisher is the user of the casting portion 20. The publisher represents the casting director or producer within the performing arts environment. The publisher will preferably also utilize the casting role 22 to define a plurality of criteria 24 associated with each casting role 22. The criteria 24 may comprise, but is not limited to the gender, age, height, weight, skin color and voice of an ideal candidate. Criteria 24 may additionally define experience of a candidate, location of the actor with respect to the production location, travel requirements, compensation expectations and many other factors. It is understood by one skilled in the art that the roles 22, the criteria 24, the publisher's subscription 26 are elements of the database 42 that are exposed or exported to the casting portion 20 to be used by this specific publisher. At any one time, a plurality of publishers may each utilize their individual casting portions 20, with all such casting portions 20 being isolated from each other.

Additionally shown in FIG. 1, is dashboard 27 displaying audition data 62. Audition data 62 is recorded by an actor or performer in actor portion 60. The actor portion 60 is preferably equipped with an auditioning platform 66. The auditioning platform 66 is preferably a set of sub-tools made available by the software application 10 to each actor/performer attempting to audition for a role. It should be noted that role 22 may be a stage role, a role in a film or any entertainment function requiring a performance of some sort, such as a magician, musician, acrobat, daredevil, trapeze walker, etc. Possible sub-tools may include, but are not limited to, a voice recorder, a sound recorder, a video recorder, recording editor and other minor controls of these features. The auditioning platform 66 is intended to both train the actor in the character expected by the role being cast, and to provide the medium to record the actual audition.

The backend portion 40 is then configured to associate role 22 with the criteria 24 for each of role 22. It should be noted that the backend portion 60 enables the auditioning platform 66 for each or performer. The backend portion 40 then utilizes actor portion 60 to collect personal actor data 68 and associate it with an audition data for each actor within actor portion 60. The backend portion 40 then assembles the audition data 62 and actor data 68 from all performers that satisfy the parameters of criteria 24 and role 22 and are presented at the dashboard 28. It should be noted that the auditioning platform 66 is configured function as a dashboard 67 for the actor to view and search for available roles and view feedback. Actor's dashboard 67 is preferably populated using data from database 22 of the backend potion 66. Still referring to FIG. 1, is the artificial intelligence component 80. The artificial intelligence component 80 assists in conducting auditions by a performer. During an audition the artificial intelligence component 80 may function as a responding character to the roles being performed by the auditioning actor. By way of an example, a performer auditioning for role of A in a scene where A is conversing with character B, the artificial intelligence component 80 taking the part of B, responds to A′s lines. The artificial intelligence component 80 may respond as different characters and provide realistic effects. Additionally, a publisher may configure the artificial intelligence component 80 to intentionally interfere or send exterior stimuli that would mimic events context of a live scene.

The artificial intelligence component 80 may fulfill other functions at the actor's portion 80. During an audition, the artificial intelligence component 80 may monitor performer's delivery of a role, response to a stimulus, ease of presentation and quality of delivery of verbal lines, voice intonations and body gestures. The artificial intelligence component 80 may provide comparisons to other performers. Additionally, the artificial intelligence component 80 may be utilized to replicate one or more than one role at a time in response to performer's lines. The artificial intelligence component 80 may be configured to permit the actor to record scenes out of sequence, or to proceed to specific point in the script, for example at a particular location during presentation, or may be configured by the publisher to permit auditions only during particular times of the day week or calendar day. Additionally, the artificial intelligence component 80 may be used to enhance the data integrity of the auditions by detecting improper access or editing. The backend portion 40 preferably discloses additional modules, such as, but not limited to a subscription management 41, the database 42a of auditioning data 62 and actor data 68 and database 42b of roles and criteria created by publishers. Alternatively, everything may utilize a single database. Also shown is a security module 43, providing for secure isolation between casting portion 20 and acting portion 60 of each actor and publisher, as well as data integrity and tamper protection against role data, actor data and auditioning data.

Additionally, the backend portion 40, the casting portion 20 and the acting portion 60 may contain a communication module for private emailing or texting from within the application. The backend portion 40 the casting portion 20 and the acting portion 60 may additionally support text editing and collaboration tolls to edit or otherwise process role data 22, auditioning data 68 or actor data 62. Computer application 10 may also expose a project management module to treat the casing of a role to filing it as a project. Additional modules that may be possible may support training of Actors or proactive actor searches by publishers/casting directors, to identify candidates based on prior experience, schooling or other information available in the library exposed by the backend portion 40.

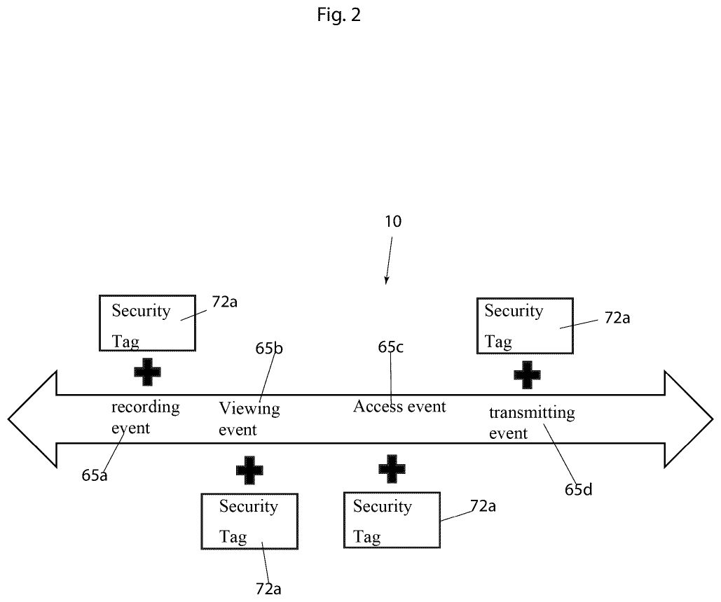

FIG. 2 shows one embodiment of authentication of data performed by computer application 10. Each event in the actor portion 60 is accompanied by a verification element 72a, which may be a tag, a code or a certificate, that is generated using random generator and is attached to each event. For example, the event of opening actor's dashboard 67 receives a verification element 72a. The acts of reviewing 65a, recording 65b and auditioning 65c, will each have their own verification elements 72a, which may be augmented by additional verification elements 72a for events that occur over time, like an audition, or a training. Each verification element 72a is then stored separately in database 42.

The data may be matched by random codes, time stamps or by association with events related to the particular data through a specific sequential occurrence to that data, or a combination of such factors. Thus, for example, if a specific recording event 65a was five minutes long and is followed by a narrator event, or a change of scenes event, all of which had a verification element 72 assigned the verification elements 72 would be aware of preceding and following events occurring during a recording. An act of tampering would be detected due to a mismatch or missing verification elements, or elements occurring out of sequence. This is just one embodiment of verification, and other or different verification methods may be implemented. Data authentication of computer application 10 is further configured to detect differences in performance by an actor, which may indicate impersonation.

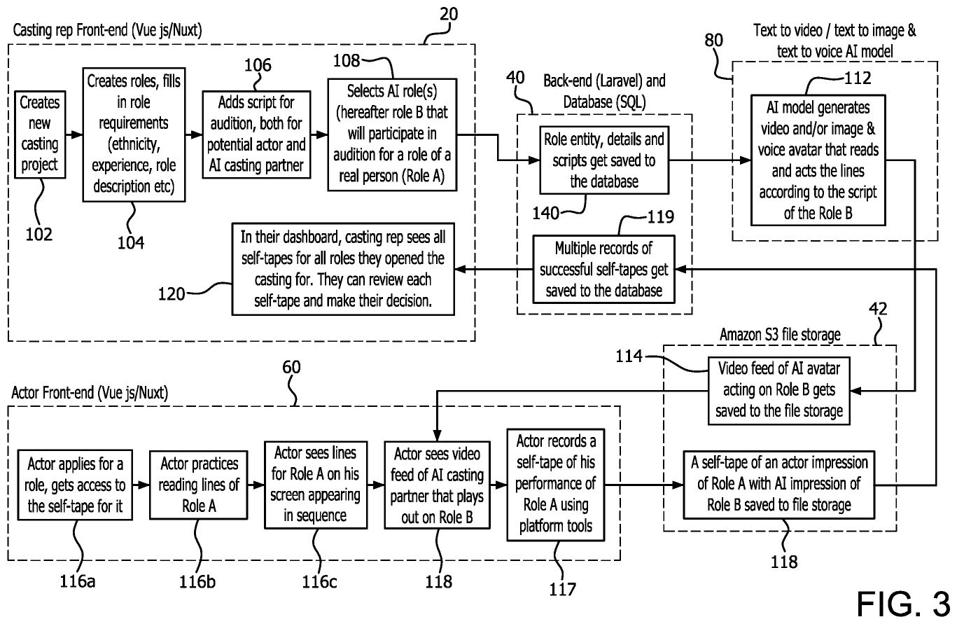

FIG. 3 provides a high-level diagram which demonstrates one embodiment in which the computer application 10 enables the method of recruitment of talent to fill open positions in the sector of entertainment and performing art, where talent is able to audition remotely with the assistance of artificial intelligence component (80).

The process begins when a publisher, who may be a casting producer, the head entertainer, etc., creates a casting project in step 102. The publisher shen defines one or plurality of casting roles (22). At this point the backend 40 may already be publishing the available roles to actors/entertainers, prompting an actor to apply for a role using the actor portion 60 in step 116a. In the application step 116a the actor may create a self-tape of personal data or may present personal data as separate entries.

The publisher creates or registers the script, for each casting role and the artificial intelligence component's (80) to function as casting partner, additional partner, narrator, multiple characters, sound effects, contextual effects producer, etc. The publisher can then configure what partner role should be carried out by the artificial intelligence component's (80) in step 108. The basic script is then transferred to the backend portion 40, where the role and its details, together with scripts and function of the artificial intelligence component's actions foe each individual casting role 22 are stored as a database entry in step 110. It should be noted that each individual feature may be recorded separately, and then assembled into features by one casting role using the data dictionary that may be configured using the artificial intelligence component 80. Thus, for example, the role 22 will be one database entry. The script for this role 22, as another database entry, the role played by artificial intelligence component 80 a separate entry. Sound effects or visual effects to be played with the role as a separate database entry. All of these entries are then assembled based on data dictionary for this role 22. These database entries may then be reused by the backend portion 40 as a library of past roles and casting parameters for future roles and auditions.

The artificial intelligence component 80 proceeds to generate a video, voice recording and other details of presenting the script that an actor will see or hear as video or audio avatar in step 112. The video created in step 112 by the artificial intelligence component 80 is then further stored in the library of roles for a track record and as part of a library for future references.

In the meantime, in the actor portion 60, the actor is given the audition platform 66 to practice his/her lines or act in step 116b and is able to practice using the lines of the script presented by artificial intelligence component 80 on the screen of the audition platform 66. Notably, the artificial intelligence component 80 may be configured to train the actor in steps 116b and 116, for example, by removing lines that the actor has read very fluently and without the slight pause required to read a line. Using this method, as the actor's presentation becomes more polished and fluid, the lines will keep disappearing off the screen, until the actor is ready to record an audition recording 117 together with artificial intelligence component 80 serving as the audition partner. It should be noted further that the training period may be a factor recorded by the artificial intelligence component 80 to be considered by the publisher. The audition tape is then recorded in database 42 of the backend portion 40 and then presented to dashboard 27 by publisher's review of the audit and actor data in step 120.

FIG. 4 is an additional diagram of method disclosed in FIG. 3. At the actor portion 20 of the computer application 10, the step 102 of creating a casting project may additionally comprise the step of defining criteria for casing project in step 102d. For example, in the step 102 of defining criteria, the publisher may fill in additional role requirements, such as ethnicity, age, experience, role description, size, weight, sex, etc. These criteria, along with the role (22) are then recorded in the database 42 of the backend portion 40 in step 110. At the same time, the role is presented to an actor/performer in step (116a) in the actor portion 60. The actor portion 60 or the backend portion 40 may be configured to present the casting role (22) being described in the present figure due to actor's defining of criteria for preferred roles sought in step 116d. The actor then submits an application for the role in step 116, which now contains actor data with actor defined criteria for the role along with standard actor's data, such as name, age, sex, ethnicity, experience, residency, etc. Using the auditioning platform (67) having an artificial intelligence component 80 playing as an auditioning partner, the actor creates an audition recording in step 117 which is then recorded in the database 42 of the backend portion 40. In the embodiment described in FIG. 4, the artificial intelligence component 80 receives and reviews the recording created in step 117 and compares it against a paradigm or evaluates the recording for important elements in step 112d. The artificial intelligence component 80 may at this point check security features to ensure data integrity of the recording. Based on its finding in step 112d the artificial intelligence component 80 makes a recommendation which is then provided to a human evaluation in the backend component 40, or to a further algorithm enabled by artificial intelligence component 80. In this case, the artificial intelligence component 80 retrieves in step 132 the actor data comprising of the actor defined criteria in step 116d and actor's application created in step 116. The artificial intelligence component 80 retrieves the casting role, criteria and other details defined by the publisher and which were recorded in step 110. The artificial intelligence component 80 then compares in step 130 the publisher criteria provided in step 102d with actor defined criteria from step 116d and further merges in step 133 the recommendation based on such comparison from step 130 with recommendations made in step 112d of audition data and displays its recommendation on the dashboard (27) in step 120.

The background portion 40 is configured to send notification about roles 22 to both multiple instances of the casting portion 20 as well as one or multiple instances of the acting portion 60. The subscribers to the messages sent by the background portion 40 may be subscribing to either an instance of the casting portion 20 or an instance of the acting portion 60, or may be a 3^{rd} party recipient the messages from the background portion 40.

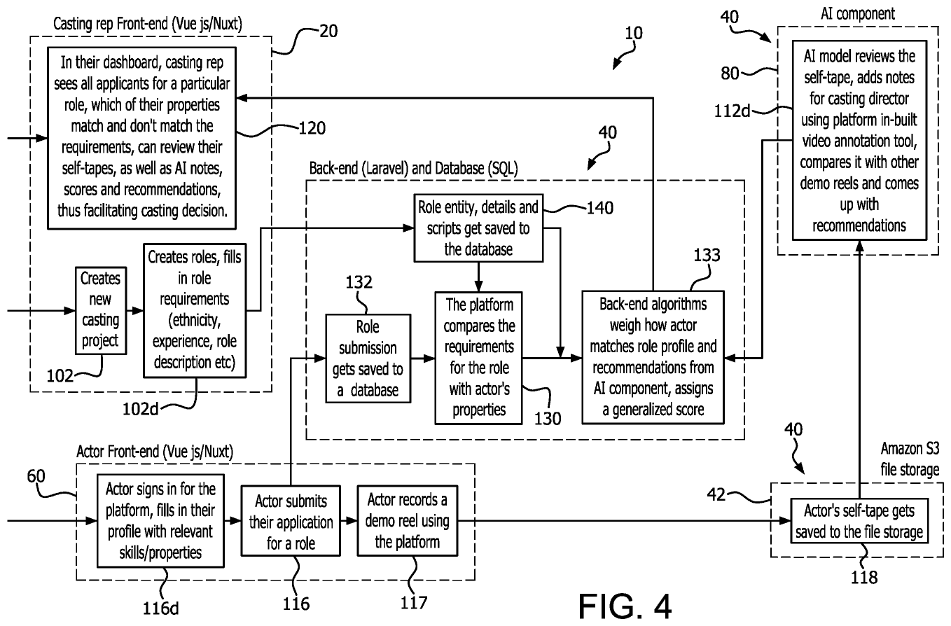

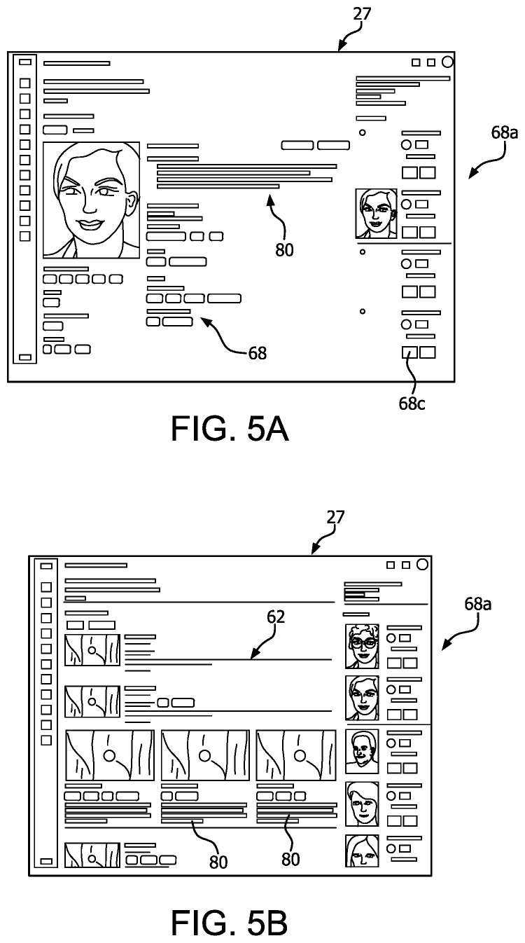

FIGS. 5A and 5B demonstrate a dashboard 27 showing the actor data 68 and audition data 62. A plurality of additional applicants are provided as a sidebar 68c. Recommendation or assessment of artificial intelligence component 80 is additionally visible next to the audition data 62.

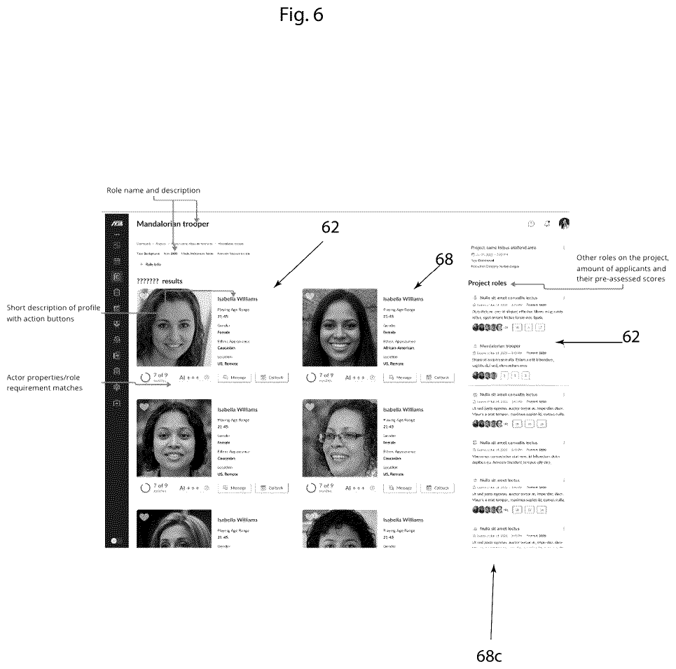

FIG. 6 demonstrates a library feature of the backend portion 40 that is displayed in the casting portion 20 or to via the audition platform 67 of actor portion 60. Shown are a plurality of actor data 68 featuring data of the applicants, or prior hires. The link to audition data 62 is provided in the sidebar 68c, or as an individual link with each actor data 68.

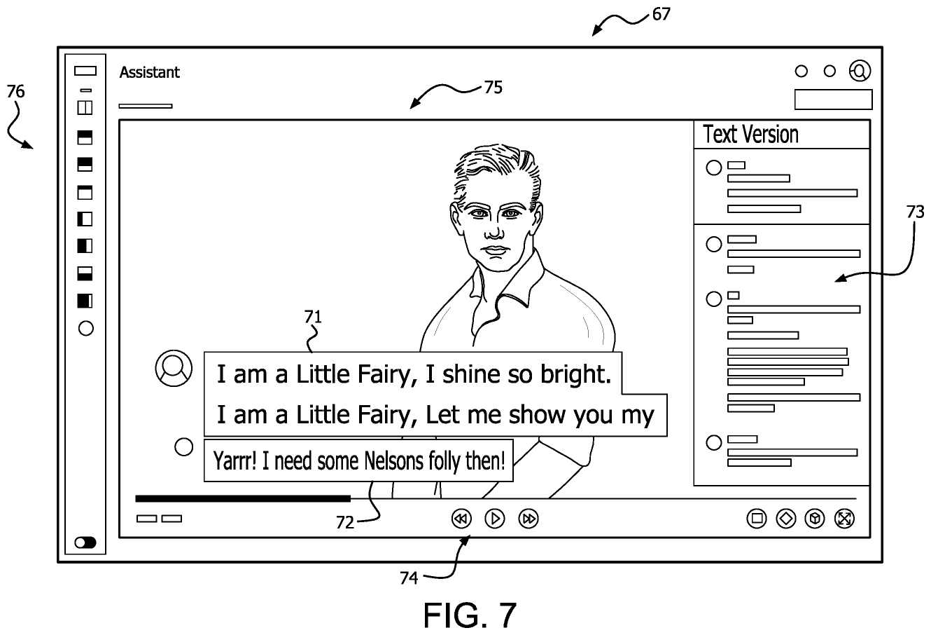

FIG. 7 is a demonstration of audition platform 67. Artificial intelligence component 80 records the image of the actor and displays it in real time via screen 75. This way, the actor gets an immediate feedback on how they appear while performing the particular scene. The sidebar 73 permits the Actor to scroll to a particular scene or a set of lines and record items out of sequence, or pause an existing audition to review a prior or future scene. An additional sidebar 76 may provide additional control and editing tool for the actor. During performance, the actor will be able to view the lines they are supposed to recite 71 and also view and hear the lines recited by the role or roles played by artificial intelligence component 80. The artificial intelligence component 80 may display the avatar representing the role it is playing via screen 75. The actor/performer can then record the entries using the audition/video control interface 74.

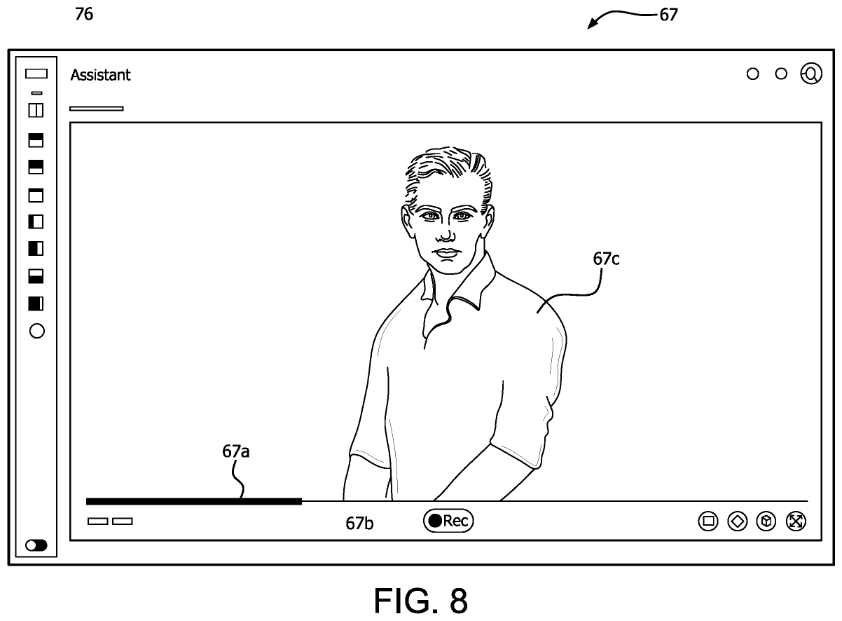

FIG. 8 demonstrates the audition platform 67, when the performer is actually recording the audition, or when the artificial intelligence component 80 determined that the actor is ready to proceed, or when the actor, based on criteria (24) set by publisher is required to proceed. The role lines (71) disappear partially or completely and the recording 67b begins. It is preferable that the recording 67b would become indelible either upon recording, or upon several tries, depending on the settings provided to artificial intelligence component 80 by the publisher. The Actor would be able to see himself or the co-role played by the artificial intelligence component 80 as image 67c. A plurality of collaboration, editing or communication tools would be available to the Actor depending on security settings enforced by artificial intelligence component 80, via the sidebar 76.

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub- combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

What is claimed:

1. The system of matching artistic talent with open roles comprising: a computer application, said computer application comprising at least three portions; wherein said at least three portions comprising of a casting portion, an actor portion and a backend portion; wherein said at least three portions being in data coordination relationship with each other; wherein said casting portion is configured to create at least one casting role, create criteria for said at least one casting role and review audition data; wherein said actor portion is configured to provide an auditioning platform to at least one actor, said actor portion further configured to create said audition data for said at least one actor; and a backend portion, wherein said backend portion storing a plurality of said at least one casting roles, wherein said backend portion configured to associate said casting role with said criteria for each of said casting roles; wherein said backend portion configured to create said auditioning platform for each said actor within said actor platform; wherein said backend portion configured to store personal actor data and audition data for each actor within actor portion; and wherein said backend portion configured to present to a publisher of said one of said at least one casting role with said actor data and said audition data that corresponds to said criteria of said at least one casting role.

2. The system of matching artistic talent with open roles of claim 1, wherein said backend portion configured to check data authenticity of said actor data or said audition data for each of said actor.

3. The system of matching artistic talent with open roles of claim 2, wherein said auditioning platform further comprising an artificial intelligence component, wherein said artificial intelligence component configured to provide a responding role to each said actor during an audition.

4. The system of matching artistic talent with open roles of claim 2, wherein said auditioning platform is configured to allow a practice period.

5. The system of matching artistic talent with open roles of claim 3, wherein said auditioning platform is configured to allow a practice period.

6. The system of matching artistic talent with open roles of claim 1, wherein said backend portion is further comprising an artificial intelligence component; wherein said artificial intelligence component is configured to provide casting and audition editing recommendation or a matching recommendation linking at least one casting role with at least one actor.

7. The system of matching artistic talent with open roles of claim 3, wherein said backend portion is further comprising an artificial intelligence component; wherein said artificial intelligence component is configured to provide casting and audition editing recommendation or a matching recommendation linking at least one casting role with at least one actor.

8. The system of matching artistic talent with open roles of claim 1, wherein said casting portion is configured to provide said publisher with a dashboard comprising at least one actor data and at least one auditioning data for said at least one actor; wherein said at least one actor data or said at least one auditioning data or said actor being similar to criteria of said at least one casting role published by said publisher.

9. The system of matching artistic talent with open roles of claim 7, wherein said casting portion is configured to provide said publisher with a dashboard comprising at least one actor data and at least one auditioning data for said at least one actor; wherein said at least one actor data or said at least one auditioning data or said actor being similar to criteria of said at least one casting role published by said publisher.

10. The system of matching artistic talent with open roles of claim 3, wherein said casting portion is configured to provide said publisher with a dashboard comprising at least one actor data and at least one auditioning data for said at least one actor; wherein said at least one actor data or said at least one auditioning data or said actor being similar to criteria of said at least one casting role published by said publisher.

11. The system of matching artistic talent with open roles of claim 3, wherein said backend portion is configured to host a library of plurality of audition data and a corresponding plurality of a actor data from a plurality of actors; said library controllingly accessible to said publisher.

12. The system of matching artistic talent with open roles of claim 11, wherein said artificial intelligence component configured to match said at least one casting role with any of said audition data in said library; and wherein said audition data and actor data presented to said publisher.

13. The system of matching artistic talent with open roles of claim 3, wherein the backend portion is further configured to offer said casting portion to said publisher as a subscription or said acting portion to said actor as a subscription; wherein said subscription being managed by said backend portion; and wherein said backend portion configured to provide authenticity and temper protection on data recorded at the casting portion and at the acting portion.

14. A method of filling character roles in the preforming arts comprising the steps of: a backend portion of a software application providing a casting portion of said software application to at least one publisher; said backend portion of said software application providing an actor portion to at least one actor; said publisher utilizing said casting portion to publish at least one casting role; said backend potion publishing said at least one casting role to a plurality of at least one of said actors; said actor utilizing auditioning infrastructure of said acting portion to create an auditioning data; wherein said actor linking said auditioning data with actor data of said actor; said auditioning data and said actor data being provided to said backend portion; said backend portion determining which of a plurality of said auditioning data and said actor data from said plurality of actors corresponds to said casting role; and said backend portion presenting a set of audition data and actor data to said at least one publisher via said casting portion, wherein said set of audition data and actor data corresponds to said at least one casting role.

15. The method of claim 14, further comprising the step of said publisher defining additional qualifying factors for said at least one casting role.

16. The method of claim 14, further comprising the step of utilizing an artificial intelligence component at the actor portion record said auditioning, wherein said artificial intelligence component configured to replicate an in person auditioning experience with an interactive experience.

17. The method of claim 16; further comprising the step of utilizing said artificial intelligence component at backend portion, wherein said artificial intelligence component of said backend portion configured to match said at least one casting role with said one of auditioning data or one of said actor data from a plurality of auditioning data or a plurality of actor data.

18. The method of claim 16, further comprising the step of assigning authentication tags to said auditioning data or said actor data as it is created by said actor.

19. The method of claim 14, further comprising the step of assigning authentication tags to said auditioning data or said actor data as it is created by said actor.

20. The method of claim 13, further comprising the step of said at least one actor receiving a listing of available roles published by said at least one publisher based on criteria for roles defined by said at least one actor.
